(19) United States
(12) Patent Application Publication
(10) Pub. No.: US 2016/0284185 A1
(43) Pub. Date: Sep. 29, 2016

(54) ACTIVE BLUETOOTH LE TAG SCANNING AND TRACKING FOR USE IN VEHICLE TELEMATICS APPLICATIONS

(71) Applicants: Neth Maison, Winchester, CA (US); Cole Randall, Temecula, CA (US); Edward Bermudez, Winchester, CA (US)

(72) Inventors: Neth Maison, Winchester, CA (US); Cole Randall, Temecula, CA (US); Edward Bermudez, Winchester, CA (US)

(73) Assignee: Global Tracking Communications, Inc., Temecula, CA (US)

(21) Appl. No.: 15/170,612

(22) Filed: Jun. 1, 2016

(51) Int. Cl. G08B 13/24; G06K 7/00; H04B 5/00

(52) U.S. Cl. CPC G08B 13/2462; G08B 13/2417; H04B 5/0025; H04B 5/0062; G06K 7/00; G06K 2017/0045

(57) ABSTRACT

Bluetooth low energy (BLE) tags and a BLE tag reader with memory track and report assets located in or on a vehicle. A BLE tag is associated with each asset and has a unique ID and received signal strength indicator (RSSI). The reader and its software cooperate to scan and read the ID and RSSI from each tag located within range without pairing with the tag, date and time stamp each ID and RSSI, store a list of IDs and RSSIs of read tags and associated data in the memory, remove IDs and RSSIs from the memory if tags are not within range, to continuously update the current status of assets, and transmit the stored list by way of the modem at predetermined times to a remote server. The remote server has a database and software that stores the transmitted list of tags and associated data in the database, and generates reports for display by an end user.

### BACKGROUND

The present invention relates generally to vehicle telematics systems, apparatus, methods, and software for tracking assets, such as cargo and inventory, in or on vehicles, and more particularly, to fleet tracking systems, apparatus, methods, and software using active 2.4 GHz tags, or beacons, employing the Bluetooth low energy (BLE) 4.0 protocol and a BLE tag reader to track assets transported by vehicles. The present invention is operative to track assets transported by moving vehicles using the BLE tags that report tag ID, received signal strength indicator (RSSI), and possibly temperature, tire pressure, and alerts, which assets may be added to and removed from the vehicle during transport, so as to monitor the presence of assets in the vehicle over time and report current, up-to-date, status of the assets in or on the vehicle.

As is discussed on the Wikipedia website, Bluetooth low energy (Bluetooth LE, or BLE) is a wireless personal area network technology primarily designed for use in the healthcare, fitness, security, and home entertainment industries. Bluetooth LE was designed to provide reduced power consumption and cost compared with Bluetooth Classic while providing a comparable communication range. It was designed for use with mobile operating systems as well as OS X, Linux, and Windows operating systems.

Furthermore, Bluetooth LE (BLE) operates in the 2.4-2.85 GHz radio frequency band and has an operational range greater than 300 feet. Bluetooth LE implements low energy application profiles based on a generic attribute profile, or GATT, a general specification for sending and receiving short pieces of data known as attributes over a low energy link. Companies have developed profiles for indoor proximity sensing, blood pressure measurement, body temperature measurement, continuous glucose monitoring, as well as profiles for sporting and fitness accessories including body composition, cycling speed and cadence, cycling power, heart rate, location and navigation, running speed and cadence, and proximity and location profiles, for example.

Global Tracking Communications Inc. (GTC) provides systems and software (Fleet Manager system) designed for GPS tracking of vehicles and other assets. Fleet Manager software residing on a GTC server(s) is used to track vehicles using GPS technology and report on vehicles and assets that are tracked. Recently, a feature set was added to Fleet Manager software that allows end users to assign BLE tags to equipment or vehicle drivers. Once tags are assigned, the Fleet Manager system can be used to trigger various alerts and run reports that detail whether a tag is, or is not within range of a GPS unit. Alerts and reports can also be produced that detail which GPS unit or driver a tag is currently assigned to. Using this system, end users are able to track their vehicles, along with assets and drivers that are within a specified range of the given vehicle. The GTC software is designed for use with computer desktops, tablets, and mobile phones.

Known attempts to implement BLE technology for asset tracking use a mobile phone's Bluetooth capabilities. This does not allow integration with hardware on a vehicle, or data processing software. It would be desirable to have systems, apparatus, methods, and software that are integrated to implement cargo and inventory tracking within vehicles. Also, currently-available prior art tag readers scan for all tags, irrespective of vehicle. It would be desirable to have systems, apparatus, methods, and software that implements a tag “whitelist” to allow reporting associated only with tags on the whitelist. Current asset tracking technology also does not utilize dead zones, which are geographically defined, real world areas in which tag data that is received by a reader is ignored. It would be desirable to have systems, apparatus, methods, and software that implement dead zones, especially as it relates to substantially colocated readers inadvertently reading asset tags located in other vehicles.

A number of patents and patent publications address asset tracking. US Patent Publication 2004/0215532, U.S. Pat. No. 7,333,015, and U.S. Pat. No. 7,479,877 disclose systems and methods for monitoring relative movement of maritime containers and other cargo. The systems and methods involve a container and cargo movement monitoring system that includes a device secured to a container, a remote server, and fixed, mobile (affixed to movable entity), and handheld (i.e., phone) readers that act as relay stations between the device and the server. It is stated that the mobile reader may be attached to a truck, ship, or railway car. The device communicates with the fixed and mobile readers using Bluetooth radio communications. It is stated that the fixed reader may be disposed on a truck towing a container. The reader is designed to detect movement of cargo to which the device is attached, and the server is designed to generate a map corresponding to positions of the cargo in the container. It is indicated that the server is configured to monitor movement of cargo, and comprises means for storing a data map representing positions of each piece of cargo, means for receiving indicators representing a current position or directional vector for a particular piece of cargo from at least one reader, and means for determining, based on the data map and the received indicators, whether a particular piece of cargo has moved beyond a predetermined threshold. It is indicated that the reader may be equipped with a GPS receiver or other positioning equipment that is used to determine when the container is approaching its destination. Thus, the server, not the reader, monitors and determines if a piece of cargo has moved beyond a predetermined threshold. If the threshold is exceeded, an alarm is activated. There is no disclosure that the reader monitors the presence of assets in the container over time during transit to identify and report on the current (up-to-date) status of the assets in the container. There is no disclosure that assets are added to and removed from the vehicle during transport.

US Patent Publication 2004/0024660 discloses a method and system for providing asset management and tracking capabilities. The method and system employs radio frequency and other asset identification devices such as RFID tags, distributed mobile computing systems that include a tag reader, a centralized data storage environments, and client-server based computing. There is no discussion regarding of Bluetooth or Bluetooth LE tags. It is stated that status of transported assets may be determined using mobile or fixed tag readers but such status relates to delivery and storage location in a warehouse or other storage site. The example discussed with reference to FIG. 5, for example, appears to indicate that a user with a handheld reader searches for an item located a laydown yard by selecting the item in a dropdown menu on the handheld reader, verifying its general location derived from the ID tag associated with the item, and walking or riding around the yard to find the item. The handheld reader beeps louder and at a higher frequency as the user moves closer to the item. Thus, the method and system are designed to physically locate assets, such as in a warehouse or laydown yard. However, there is no disclosure regarding the use of the reader on a vehicle that transports assets, or that the reader monitors the presence of assets in a vehicle during transit over time to identify and automatically report on the current (up-to-date) status of assets in the vehicle.

U.S. Pat. No. 8,219,466 discloses a system and method for providing asset management and tracking capabilities. The system and method employ RFID tags and sensing elements affixed to assets that are transported. The tags each include a processor and a transceiver to permit tag-to-tag communication. A server computer stores information relating to asset identification. A remote client computer system is connected to the server and to an interrogation device that includes a tag reader and that interfaces between the tags and the remote client computer system. However, there is no disclosure regarding the use of the interrogation device or reader on a vehicle that transports assets, or that the reader monitors the presence of assets in a vehicle during transit over time to identify and automatically report on the current (up-to-date) status of assets in the vehicle.

US Patent Publication 2009/0309731 discloses a method and system for tracking objects using a GPS receiver built into an active RFID receiver. The position of an object is determined using the GPS receiver. The object is detected in a small range using active RFID, and the location data is sent using Global System for Mobile Communication (GSM) to a database that stores the location data. A Geographical Information System (GIS) application is used to plot the location data on a map, to track the exact location of the object. The active RFID tags send out a hard coded ID on predefined intervals that is received and interpreted by the active RFID receiver. A fixed IP remote server receives the output message generated by the active RFID receiver. The method and system are designed to track the exact location of an object and plot its position on a map. However, there is no disclosure regarding the use of the active RFID receiver or GPS receiver on a vehicle that transports assets, or that the active RFID receiver monitors the presence of assets in a vehicle over time to identify and automatically report on the current (up-to-date) status of assets in the vehicle. It is the remote server that stores the tag IDs, and there is no disclosure that the RFID receiver removes tag IDs if they are not within range of the RFID receiver to maintain a current, up-to-date, list of IDs corresponding to assets in the vehicle during transit over time in the RFID receiver. Also, there is no disclosure regarding the use of Bluetooth or Bluetooth LE tags.

U.S. Pat. Nos. 8,576,095 and 8,334,879 disclose asset management systems and methods involving tools and techniques for tracking assets, such as high-value tools, customer equipment, testing equipment, technicians, and/or the like. Some of these tools and techniques can be used to track assets in a mobile environment (such as in a delivery truck, installation van, and/or the like). It is disclosed that wireless tracking transceivers may be deployed in vehicles for use in tracking tags, and that these transceiver(s) can be used to determine, at a given point in time, whether the asset is located within a vehicle. Information is transmitted from the tracking devices (tags) primarily using long wave magnetic signals compliant with the IEEE 1902.1 standard. These tags do not function like BLE tags. It is disclosed that passive RFID tags may be employed, and it is alluded that Bluetooth IEEE 802.15 compliant tags may be used, but no implementation details are provided. More specifically, it is stated that “These wireless asset-tracking devices 125 can employ any of a variety of technologies that allow for identification and/or tracking of an item wirelessly. Many such wireless asset-tracking devices 125 may take the form of unobtrusive tags that can be affixed to, placed within, integrated with, and/or manufactured in various assets to be tracked (and/or the packaging of such assets). Merely by way of example, certain embodiments might employ, as wireless asset-tracking devices, tags compliant with the Institute of Electrical and Electronics Engineers (“IEEE”) 1902.1 standard, which specifies a long-wave, magnetic communication transport. A particular embodiment, for example, may employ RUBEE™ tags commercially available through Visible Assets, Inc., which can source RUBEE™ tags in conjunction with its patented designs. Additionally and/or alternatively, other types of wireless asset-tracking devices may be used. Examples can include, without limitation, radio frequency identification (“RFID”) tags (e.g., tags compliant with ISO/IEC 18000 and related standards), ZIGBEE™ devices and/or other IEEE 802.15 compliant devices, devices capable of communicating via Wi-Fi, CDMA, GSM, WiMAX, and other wireless standards.” There is no discussion regarding communicating data from the tags to the reader, only that Bluetooth 802.15 technology is one of many that can be used to allow identification and/or tracking of an item wirelessly.

It is stated that “the mobile asset tracking system might periodically (either on schedule, based on a query from the asset tracking computer system (i.e., remotely located computer) and/or based on a status change, such as movement, of the vehicle or asset) transmit updated asset tracking data (which may, but need not necessarily, include information received from the tracking device). This updated data may indicate that the asset has not moved since the last set of asset tracking data was sent; alternatively, this data could indicate movement of the asset with the vehicle and/or could indicate that the asset has left the vehicle, returned to the vehicle, or moved within the vehicle. In an aspect, these updates may be displayed substantially in real time (i.e., as the data is received from the mobile asset tracking system) for the user, allowing a user to monitor the location of the asset with a high degree of precision.” However, there is no disclosure regarding the use of received signal strength indicators (RSSIs) that are part of a tag. It is disclosed that GPS data is used in conjunction with the vehicle data acquisition system, but nothing is disclosed indicating that the mobile asset tracking system is coupled to a GPS device. There is no specific disclosure that the mobile asset tracking system scans and reads a unique ID and RSSI derived from a tracking device, and specifically an active BLE tag. Also, nothing is disclosed indicating that the transceiver monitors the presence of assets in a vehicle over time by scanning and reading tag ID and RSSI data to identify and automatically report on the current (up-to-date) status of assets in the vehicle. It appears that the remotely-located asset tracking computer system must be used to generate a query of the mobile asset tracking system in a vehicle in order to update asset status. Vehicle asset updates are not automatic. It is stated with reference to FIG. 4 that “The field asset management system may send a vehicle reader query to the mobile asset tracking system via GeoManager for real-time update of field asset status (block 424), and/or mobile asset tracking system might respond to real-time status inquiries via GeoManager in-vehicle hardware (e.g., a vehicle data acquisition system and/or mobile asset tracking system) and/or on-line application (block 425).” Updating of the status of assets in a vehicle is initiated from a remote computer (asset tracking computer system or GeoManager). It is also stated that “Data queries are sent out over a Wide Area Network from the field asset management system to query vehicle status on inventoried high value items or current vehicle driver (block 413) . . . . Vehicles receive the field asset management system data messages from the WAN (block 415), and vehicles respond back to the Field Asset Management System with inventory level and current driver information (block 416)” The mobile asset tracking system in the vehicle does not monitor the status of assets in or removed from the vehicle, it only responds to queries from the remote computer. There is no disclosure that the transceiver removes tag IDs and RSSIs from a memory of the mobile asset tracking system if they are not within range of the transceiver to maintain a current, up-to-date, list of IDs corresponding to assets in the vehicle during transit over time in the transceiver.

U.S. Pat. No. 7,623,033 discloses, in its Summary, a system and method “for tracking items. The system and method for tracking items may store in memory first association data reflecting an association between an item tracking device and a beacon device when the item tracking device is within a predetermined range of the beacon device. The item tracking device may correspond to a first item, and the beacon device may correspond to an area that contains multiple items including the first item. The system and method for tracking items may periodically transmit sensor data to a database. The sensor data may be transmitted to the database from the beacon device to provide information about an environment of a group of items from the multiple items within the predetermined range of the beacon device.” Item tracking devices (tags) are associated with items that are to be tracked. The item tracking devices may store information associated with an item tracking number for a corresponding item. Beacons are used to track the tracking devices. A beacon may be disposed in a delivery vehicle that carries items. The item tracking devices may directly communicate with a remote tracking center via a network or may communicate via a beacon that is in range. Updated information regarding an item removed from a vehicle is communicated by the associated item tracking device to the remote tracking center. However, nothing is disclosed regarding the use of BLE tags or BLE tag readers. Nothing is disclosed regarding the use of received signal strength indicators (RSSIs). Nothing is disclosed regarding maintaining a current record of BLE tagged assets in the vehicle over time in terms of unique ID and RSSI values. Nothing is disclosed regarding communicating the unique IDs and RSSIs and date and time stamps of active BLE tags that are currently within range of the reader at predetermined times by way of the modem to the remote server to report up-to-date status of the assets in the vehicle. Nothing is disclosed regarding the use of a BLE tag reader that communicates with a remote server via a modem to update the remote server with the current record of BLE tagged assets in the vehicle.

There is no disclosure or suggestion contained in any known prior art reference relating to the use of active BLE tags associated with assets located in or on a vehicle, such as cargo and inventory, and a BLE tag reader disposed in or on the vehicle to implement vehicle cargo and inventory tracking during transit, wherein assets may be added to and removed from the vehicle during transport, and which cooperate to generate and automatically report an up-to-date list of BLE tags and location data over time corresponding to the current, up-to-date, status of the assets in the vehicle.

It would therefore be desirable to have systems, apparatus, methods, and software for use in tracking cargo and inventory within vehicles using active BLE tags and a cooperative vehicle-located BLE tag reader.

### BRIEF DESCRIPTION OF THE DRAWINGS

The various features and advantages of the present invention may be more readily understood with reference to the following detailed description taken in conjunction with the accompanying drawings, wherein like reference numerals designate like structural elements, and in which:

FIG. 1 is a diagram showing an exemplary cargo and inventory tracking system or apparatus employing active Bluetooth low energy (BLE) tags, or beacons;

FIG. 2 is an enlarged view of the vehicle shown in the system or apparatus depicted in FIG. 1;

FIG. 3 illustrates sensed BLE tags that are within range of the tag reader;

FIG. 4 is a flow diagram illustrating processing performed in the tag reader;

FIG. 5 illustrates an exemplary BLE tag employed in the system or apparatus depicted in FIG. 1;

FIG. 6a is a block diagram of an exemplary BLE tag reader, and FIG. 6b illustrates details of the exemplary BLE tag reader; and

FIGS. 7a and 7b show details of the exemplary BLE tag reader shown in FIGS. 6a and 6b.

### DETAILED DESCRIPTION

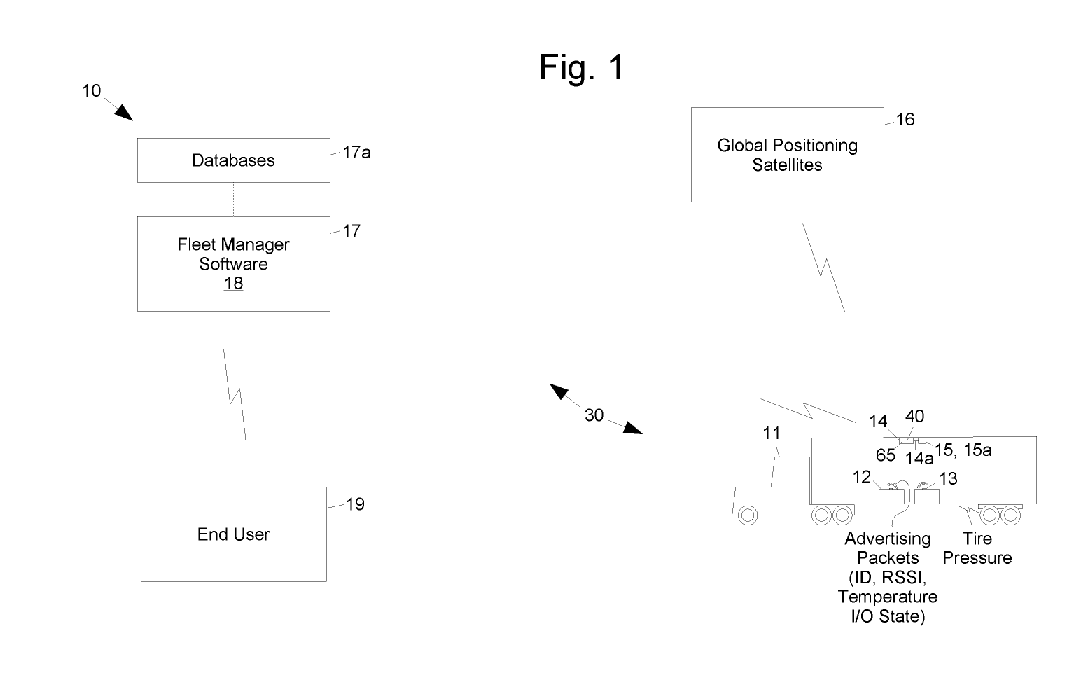

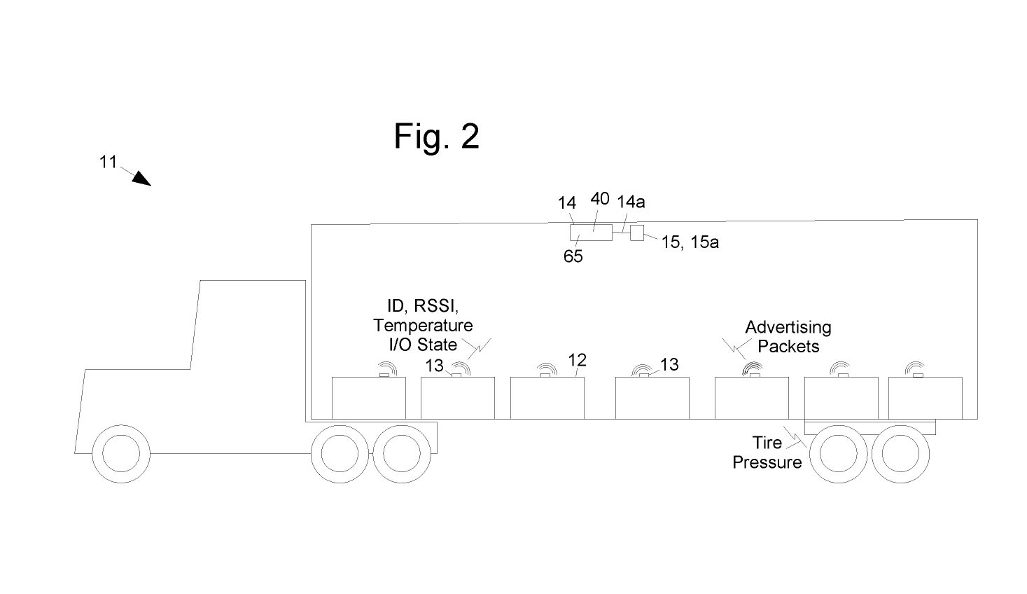

Referring to the drawing figures, disclosed are exemplary systems 10 or apparatus 10, methods 30, and software 40 for tracking assets 12, such as cargo and inventory 12, within vehicles 11 using active Bluetooth Low Energy (BLE) tags 13, or beacons 13, and a BLE tag reader 14. Bluetooth technology is used in the present invention to communicate data between two or more Bluetooth compatible devices, namely, the BLE tags 13 or beacons 13, and the BLE tag reader 14. In contrast, RFID technology is used to communicate between an antenna or reader and a tag attached to an object. FIG. 1 is a diagram showing an exemplary cargo and inventory tracking system 10 or apparatus 10 employing active Bluetooth low energy (BLE) tags 13, or beacons 13. FIG. 2 is an enlarged view of the vehicle 11 shown in the system 10 or apparatus 10 depicted in FIG. 1.

The BLE tag reader 14 is disposed in the vehicle 11 and may include an optional on-board GPS device and modem (not shown), or may be coupled to or serially-connected to an optional external GPS device 15 and/or to a GPS unit 15, and at a minimum is coupled to a modem 15a. The optional GPS device 15 is used to provide vehicle location data, and an exemplary optional GPS device 15 may have a built-in or connected modem 15a. Use of the GPS device 15 is not the focus of the present invention, which is designed to monitor and continuously update the presence of assets in the vehicle over time and report current, up-to-date, status of the assets in the vehicle 11. The GPS device 15 receives signals from GPS satellites 16 and determines its location, and thus the location of the vehicle 11, and by inference, the location of assets 12 in the vehicle. The optional GPS device 15 comprises a modem 15a for communicating with a remote server 17, and with a remote computer (not shown) to allow programming of the BLE tag reader 14. If no GPS device 15 is present, BLE tag reader is coupled to the modem 15a. In a reduced-to-practice embodiment, the BLE tag reader 14 is serially connected to a GPS device comprising a modem 15a, or alternatively may be serially connected to a modem 15a. The BLE tag reader 14 and active BLE tags 13 are used to track cargo and inventory 12 within vehicles 11 while the BLE tag reader 14 is connected to the modem 15a (and optional GPS device 15). The BLE tag reader 14 comprises an on-board memory 65 for storing data relating to the BLE tags 13. The systems 10, apparatus 10, methods 30, and software 40 are configured to have the BLE tag reader 14 constantly scan for active BLE tags 13 associated with the cargo and inventory 12, store each found BLE tag 13 in memory 65, if a previously found tag is not scanned after a 30 second period, for example, and which is configurable, remove the unscanned tag from the memory 65 based upon a stored time stamp, and automatically report the presence of the scanned BLE tags 13 at predetermined intervals, without user intervention or query, as long as they are in range of the BLE tag reader 14. The active BLE tags 13 may also be used to track drivers of the vehicles 11, and provide information relating to the assets 12 and/or vehicles 11. The active tags 13, or beacons 13, that implement the Bluetooth Low Energy 4.0 protocol, and do not use a UHF protocol.

The active BLE tag solution implemented in the exemplary systems 10, apparatus 10, methods 30, and software 40 involves two primary pieces of hardware; the BLE tag reader 14 and the BLE tags 13. In an exemplary embodiment, the BLE tag reader 14 is installed on or in a vehicle 11 and connected via a wired connection 14a to the modem 15a and optional GPS unit 15, if employed. This connection 14a allows direct communication with the modem 15a and optional GPS unit 15, and its internal modem 15a, for example, which is used to communicate information that the reader 14 receives to one or more GTC Fleet Manager servers 17. Once received by the servers 17, the data is processed and stored in GTC databases 17a, and is processed by the Fleet Manager software 18 to display and report tracking information to end users 19.

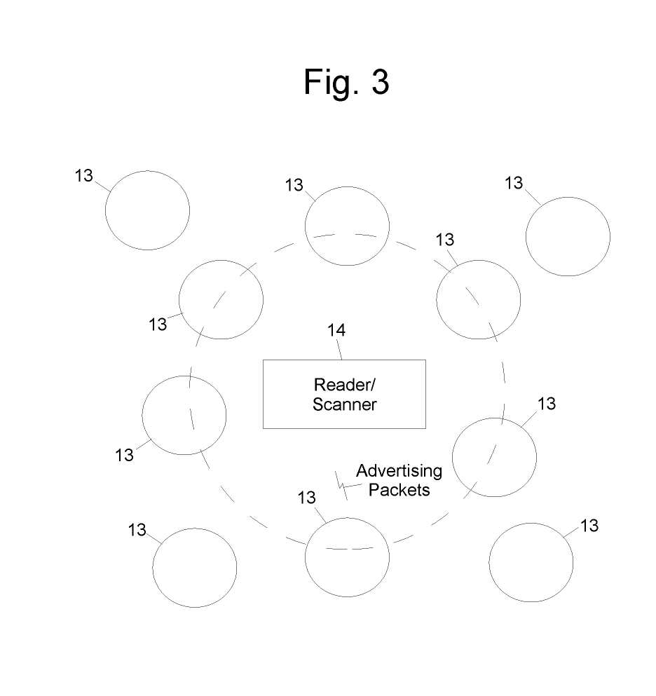

The BLE tag reader 14 is a 2.4-2.85 GHz active scanning device that constantly scans the area around it for BLE tags 13. FIG. 3 illustrates sensed BLE tags 13 that are within range of the BLE tag reader 14. FIG. 3 shows six tags 13 in range of the BLE tag reader 14, although FIG. 3 is not representative of a typical installation, where all cargo 12 and associated tags 13 are within range (˜200 feet) of the BLE tag reader 14 when the cargo 12 is in the vehicle 11. The vehicle 11 is loaded with assets 12 and are discoverable if they are within range of the BLE tag reader 14. The BLE tag reader 14 initiates an inquiry to find discoverable BLE tags 13. Each BLE tag 13 respond to the inquiry by transmitting its unique ID (MAC address), RSSI value, temperature, and I/O state, for example, as advertising data, without connecting (pairing) with the BLE tag reader 14. The connection between the BLE tag reader 14 and the BLE tag 13 continues until the BLE tag 13 is out of range of the BLE tag reader 14. The BLE tag reader 14 does not connect (i.e., bond or pair) to each BLE tag 13 within range. The “advertising” (i.e., advertising packets) associated with each of the BLE tags 13 is configured to reveal its unique ID (MAC address), RSSI value, temperature, and I/O states for example. The BLE tag reader 14 does not control the BLE tags 13 in any way, and simply scans and stores the data that is sent in the advertising packets. Consequently, there is no limit to the number of BLE tags 13 that may transmit data to the BLE tag reader 14, or that may be reported upon by the BLE tag reader 14. Thus, the present systems 10, apparatus 10, methods 30, and software 40, 18 can report on an unlimited number of BLE tags 13, and thus assets 12, transported by a vehicle 11. Bluetooth LE advertising channels (i.e., channels 37, 38 and 39), and their implementation and use, are well understood by those skilled in the art and are discussed in detail in the literature, such as in “A BLE Advertising Primer,” published by Argenox Technologies, or “Bluetooth® Low Energy Beacons,” application report number SWRA475, January 2015, published by Texas Instruments, for example, or by visiting the Bluetooth Special Interest Group website (bluetooth.com), and reviewing the Bluetooth specification v4.2, for example.

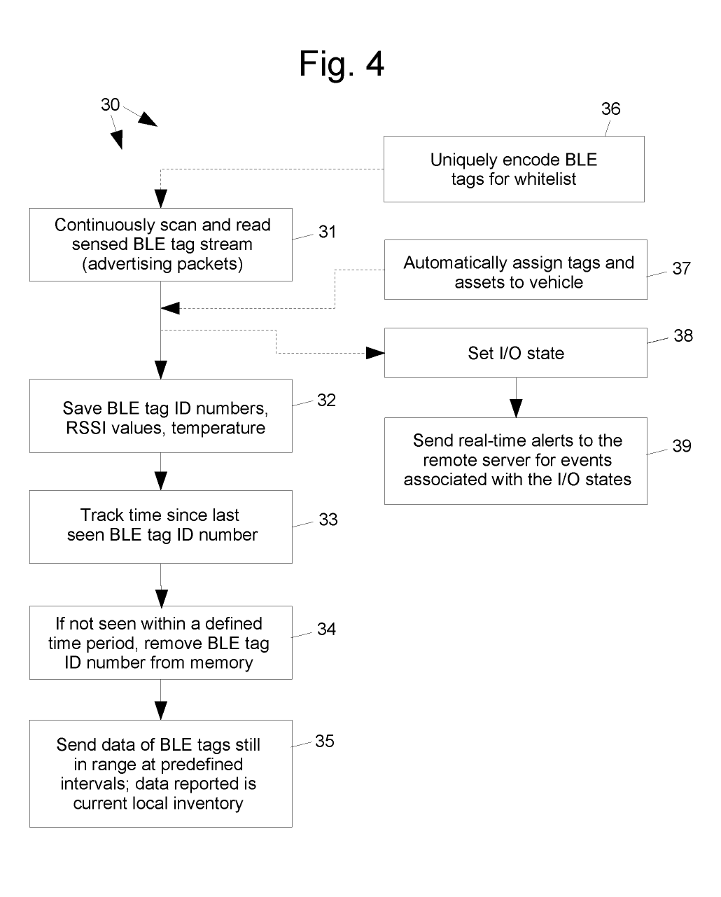

FIG. 4 is a flow diagram illustrating an exemplary processing methods 30 performed by the BLE tag reader 14 and software 40. The BLE tag reader 14 continuously scans and reads 31 the sensed BLE tag data stream. The BLE tag reader 14 saves 32 to, or stores 32 in, memory 65 each unique tag ID and received signal strength indicator (RSSI) along with other possible data including temperature, tire pressure, and door and sensor alerts 39, for example. The time is tracked 33 since receipt of the last seen BLE tag 13. If a tag has not been seen within a predefined time period, the BLE tag 13 and date/time stamp are removed 34 from the memory 65. For tags 13 in range of the BLE tag reader 14 at the end of the predefined time period, or interval, which constitutes local asset inventory, the tag ID and RSSI for each tag 13 are transmitted (reported) 35 to the remote server 17. The reporting is automatic and does not involve a query or request from the remote server 17 or the end user 19.

More particularly, as tags 13 are found, their data are stored 32 in the on-board memory 65 of the reader 14. The data that is stored 32 preferably contains a unique tag ID, a received signal strength indicator (RSSI) corresponding to the approximate distance of the tag 13 from the reader 14, and the associated and date/time stamp. Software code 40 or software 40 is programmed into the reader 14 that allows the reader 14 to keep track 33 of the tags 13 within its scannable area. As new tags 13 are found, or previously found tags 13 are no longer found, the list of detected tags 13 is updated in the on-board memory 65 of the reader 14. At predefined intervals, the BLE tag reader 14 sends 35 the current (up-to-date) list of known tags 13 to the optional GPS unit 15 via the connection 14a, or to the modem 15a, and the modem 15a and optional GPS unit 15 are scripted to receive this information and send it over the air (OTA) by way of the modem 15a to the GTC servers 17 for processing and storage in the database(s) 17a. Additional processing will be discussed below.

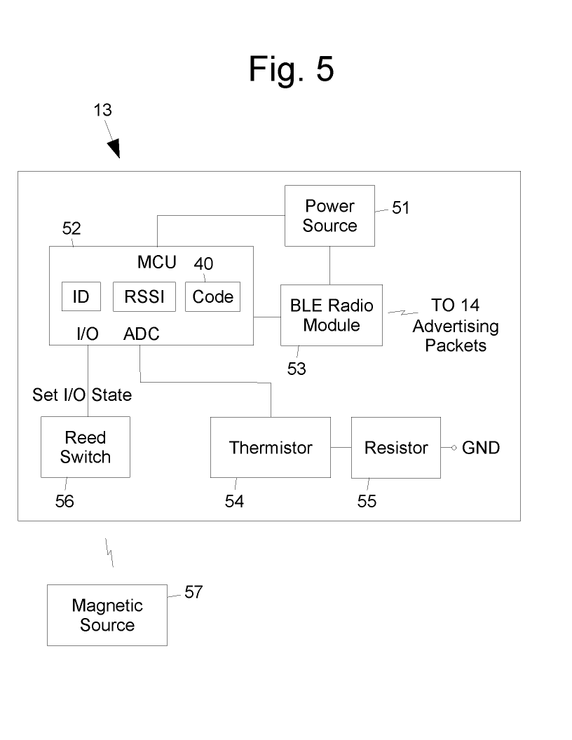

Presented below are details regarding an exemplary BLE tag 13. FIG. 5 illustrates an exemplary BLE tag 13 employed in the system or apparatus depicted in FIG. 1. The exemplary BLE tag 13 comprises a power source 51, such as a battery, that is coupled to a micro controller unit (MCU) 52 and a BLE radio module 53, operating at 2.4-2.85 GHz. The microcomputer module (MCU) 52 is programmable to implement various aspects of the present invention. The BLE tag 13 is configured to transmit advertising data, without a Bluetooth radio connection, to the BLE tag reader 14.

As is shown in FIG. 5, temperature reporting 34 is implemented using a thermistor 54 and a resistor 55, that are part of the BLE tag 13. The thermistor 54 is connected to an ADC input of the MCU 52 and through the resistor 55 to ground (GND) to measure ambient temperature. The resistance value of the thermistor 54 changes due to temperature and by calculating the difference between the resistance value of the thermistor 54 and the value of the resistor 55, local temperature can be determined with an accuracy of ±0.25° C. in a temperature range of −55° C. to 125°. The temperature value is determined in the BLE tag 13, but this is an analog-to-digital converter (ADC) value of the thermistor. This temperature value is converted to a real temperature value in the BLE tag reader 14. Reporting temperature data is useful in situations where the assets are temperature sensitive, wherein doors of the vehicle 11 are opened and closed to add or remove temperature sensitive assets such as frozen food, for example. The BLE tag 13 also includes a reed switch 56 that is used to set 38 (FIG. 4) an input/output (I/O) state (on/off) when triggered by an external magnetic source 57. When the reed switch 56 is near the magnetic source 57, the reed switch 56 is closed and the I/O is set 38 to ground. Triggering the reed switch 56 sends a message to the BLE tag reader 14 and any subsequent messages will contain the I/O state. Setting this I/O state is useful for door sensing. For example, if the door is closed, the reed switch state is low, and when the door opens, the absence of magnetism triggers the reed switch 57 to be in a high I/O state.

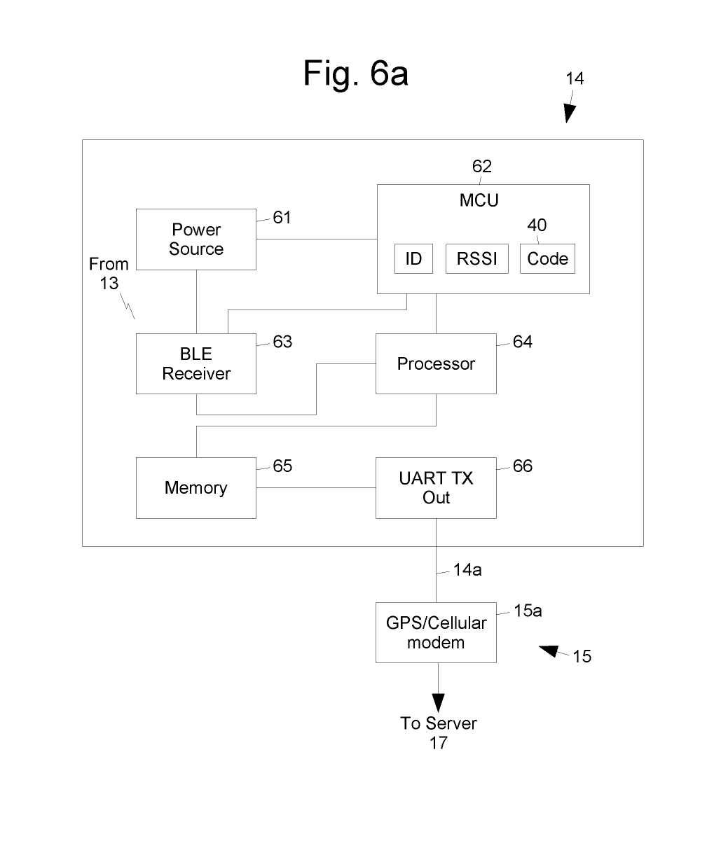

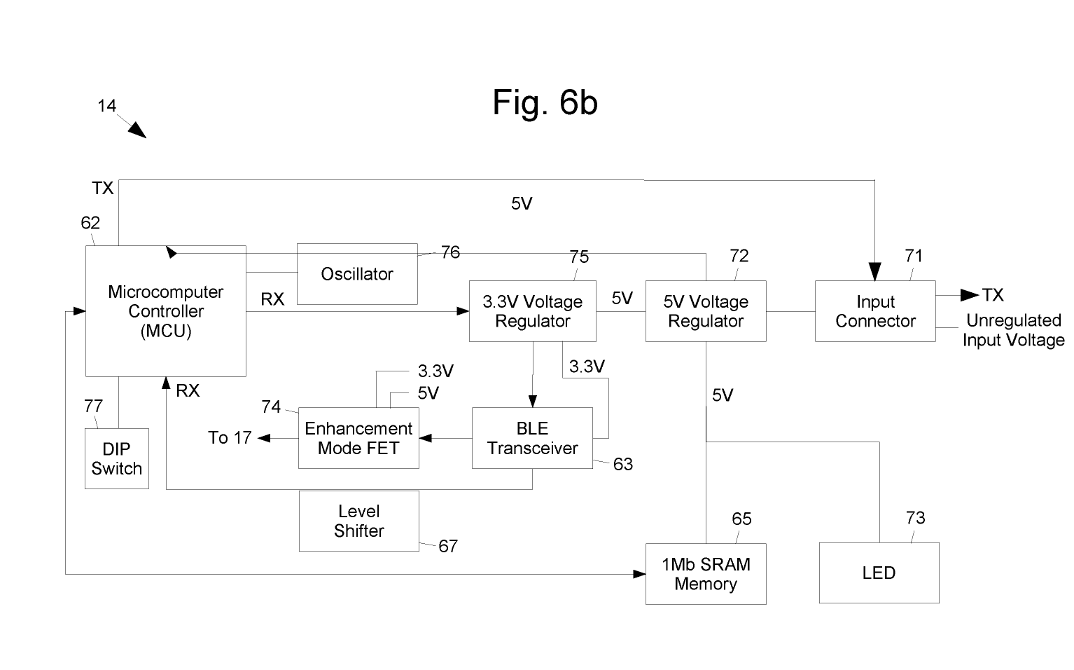

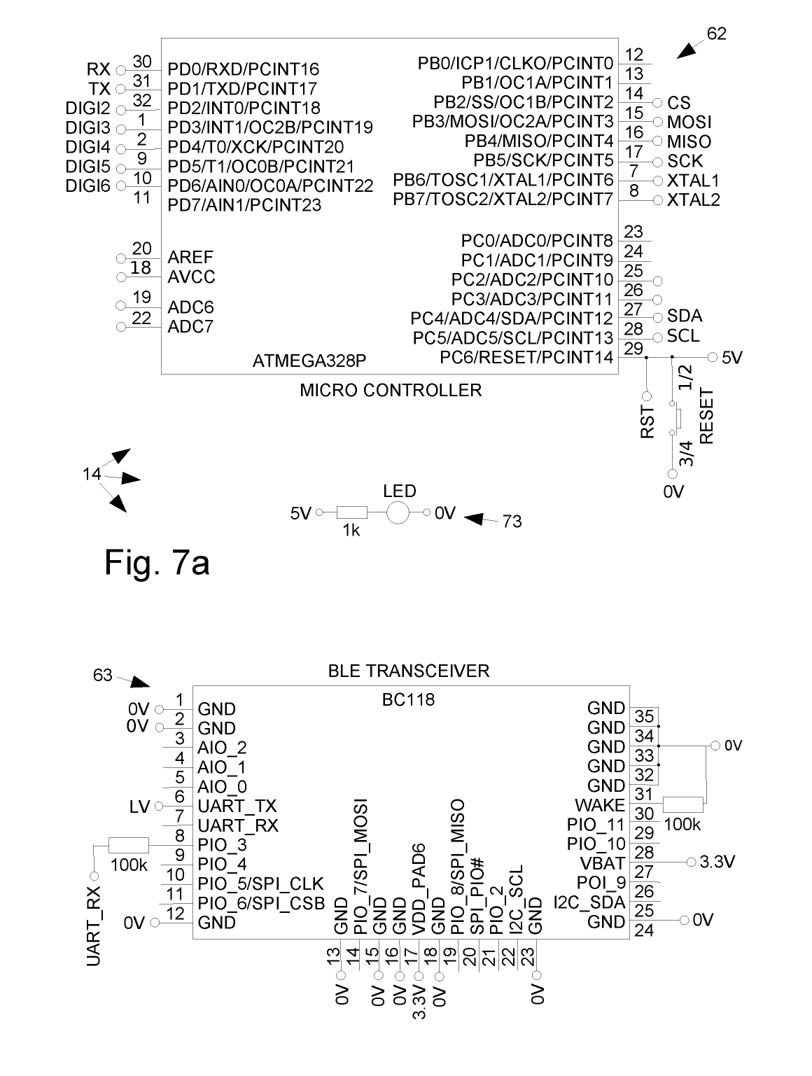

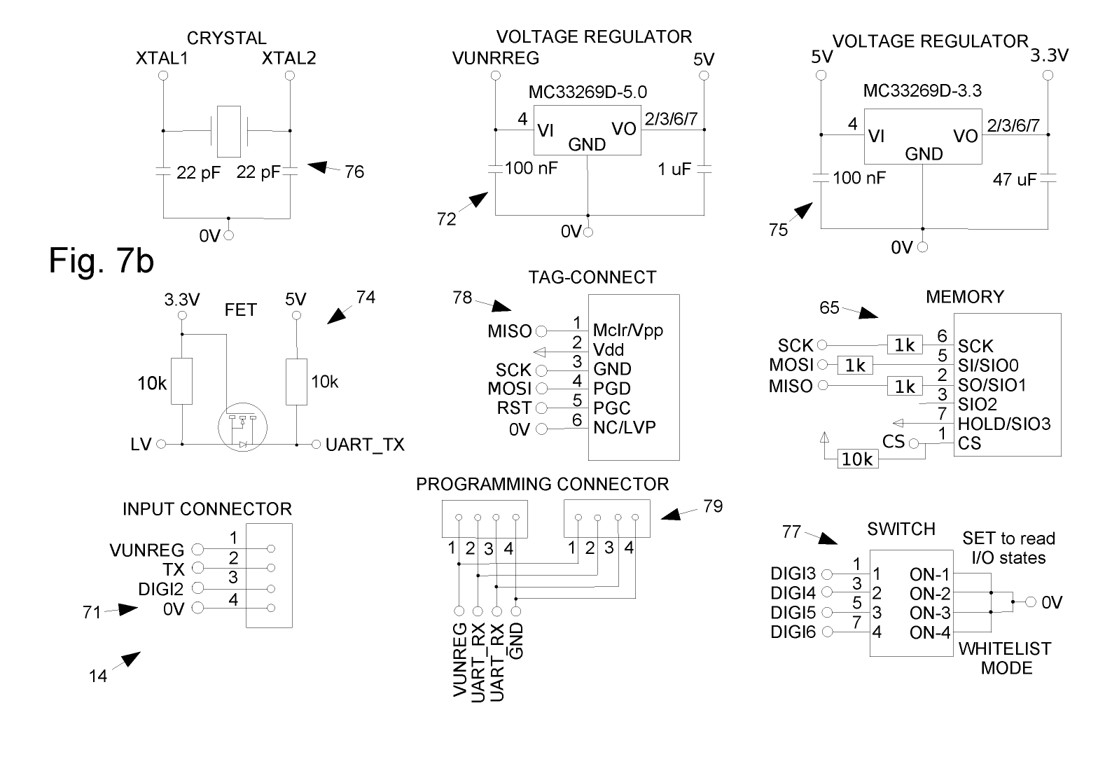

Presented below are details regarding hardware aspects of an exemplary BLE tag reader 14. Reference is made to FIGS. 6a, 6b, 7a and 7b, which show block and detailed diagrams of an exemplary BLE tag reader 14. FIG. 6a is a block diagram of an exemplary BLE reader 14, and FIG. 6b illustrates details of the exemplary BLE reader 14. FIGS. 7a and 7b show details including individual sub-circuits of the exemplary BLE tag reader 14 shown in FIGS. 6A and 6b.

As is shown in FIG. 6a, the exemplary BLE tag reader 14 comprises a power source 61, such as a battery, that is coupled to a micro controller unit (MCU) 62 and a BLE radio module 63, or BLE receiver 63, operating at 2.4-2.85 GHz. The microcomputer module (MCU) 62 is coupled to the BLE receiver 63 and to a processor 64. The microcomputer module (MCU) 62 is programmable to implement various aspects of the present invention. The BLE receiver 63 is configured to scan for BLE tags 13 and receive data from the BLE tags 13. The processor 64 is coupled to an external memory module 65 (memory 65) that is used to store data associated with the BLE tags 13 that are scanned and read. The memory module 65 is coupled by way of a universal asynchronous receiver/transmitter (UART) 66 to a GPS/Cellular modem 15a. The GPS/Cellular modem 15a sends data to the remote server 17.

As is shown in FIG. 6b, input power to the reader 14 is fed via a 4-pin input connector 71, such as a Molex SIL4 connector, into a 5V voltage regulator 72, such as an ON Semiconductor model MC33269D-5.0, which powers a microcomputer unit (MCU) 62, such as an Atmel Corp. model ATmega328P, LED 73, on-board memory (RAM) 65, such as a Microchip Memory model 23LC1024, an enhancement mode field effect transistor (FET) 74, and a 3.3 voltage regulator 75, such as an ON Semiconductor model MC33269D-3.3. The 3.3 voltage regulator 75 powers a BLE transceiver module 63, such as BlueCreation model BC118. Data is transmitted via a UART transmit data line (TX) from the MCU 62 as an output of the BLE reader 14 to the GPS/Cellular modem 15a for transmission to the remote server 17. Data is transmitted from the BLE transceiver module 63 by way of a logic level shifter 67 that shifts the voltage from 3.3 v to 5 v, and the level-shifted data is input to a receive data line (RX) of the MCU 62.

The MCU 62 is connected to the external memory 65 (1 Mbit RAM 65) using the Serial Peripheral Interface (SPI) protocol. The MCU 62 is coupled to an oscillator 76 that oscillates at a 16 Mhz crystal frequency for timing synchronization. In-circuit serial programming (ICSP) pins of the MCU 62 have been assigned to an on-board ICSP header 78 (TAG-CONNECT) addressable via a cable-to board-adaptor for flashing the MCU 62 with a bootloader (ROM code that initializes the MCU 62 at startup) and software code (i.e., software 40). Headers are provided to exclusively address and configure the BLE module 63. Four digital inputs of the MCU 62 are controlled by a 4 pole DIP switch 77 providing the ability to set or unset each to a grounded state. A programming connector 79 is provided for programming the BLE transceiver module 63. The programming connector 79 is a direct serial communication power and ground to the BLE transceiver module 63, and is used to configure the BLE transceiver module 63.

Using this circuitry, the BLE tag reader 14 can be powered with 6-20 VDC. With the code written to the MCU 62 and the BLE module 63 properly configured, upon startup, the reader 14 initiates a serial connection at a 9600 bps baud rate, waits 1 second and send the response PWR through the TX line of the MCU 62. The BLE tag reader 14 then idles until the input line located in the input connector 71 is set to a grounded state, this enables the scan and report function of the code. Once grounded (and all DIP switches are ungrounded), the Bluetooth 4.0 media access control (MAC) addresses (in Hexadecimal format) and RSSI values (in Hexadecimal format) sensed through the BLE module 63 are stored in the RAM 65 along with the time the particular MAC address was sensed by the BLE module 63 and a five minute timer, for example, which is configurable, is begun. During the five minute (configurable) timer countdown, as more MAC addresses are sensed by the BLE module 63, they are added to the memory 65. If a MAC address is already saved to the memory 65, the last seen time and RSSI value are updated to the latest reported values. If the last seen time exceeds 30 seconds, or other configurable time period, the MAC address is removed from the memory 65.

Once the five minute (configurable) timer elapses, the MAC addresses and associated RSSI values stored in the memory 65 are written to the MCU TX data line with a prefix header indicating the number of device MAC addresses in memory 65 and the addresses and RSSI values with a precursor “+” before each one. For example, if two devices are sensed, what is seen is “D002+20FABB000001CA+10FABB000002D8”.

The five minute countdown timer is then restarted for another five minute countdown. If during the five minute timer countdown the input state is no longer grounded, the contents of the memory 65 is immediately sent through the MCU TX data line, and afterwards the memory 65 is cleared.

With the DIP switches set, code operation can be altered. With DIP switch 1 set to ground, the BLE tag reader 14 will not wait five minutes to report sensed MAC addresses and RSSI values when the input in the connector 71 is grounded, but instead will report immediately in real-time. For example: “+20FABB000001CA” the MAC address and RSSI value is still saved to the memory 65 and will only report once (if not in the memory 65). If a BLE tag 13 is not sensed again by the BLE module 63 within 15 seconds, the MAC address are reported as no longer seen by prefixing a “−” before the MAC address and there will not be an RSSI value. For example: “−20FABB000001”.

If DIP switch 2 is grounded and DIP switch 1 is unset, the 5 minute countdown timer becomes 10 minutes. If DIP switch 2 is grounded and DIP switch 1 is grounded, the timeout for sending dropped MAC addresses becomes five seconds.

If DIP switch 3 is grounded and DIP switch 1 is unset, temperature values (in Fahrenheit) are reported from supported BLE tags 13, and are appended after RSSI values in the messages. For example: “+20FABB000001CA75”.

If DIP switch 4 is grounded and the input in the connector 71 is not grounded, this enables local whitelist mode. Any BLE tags 13 sensed while DIP switch 4 is grounded are stored into memory 65. To save the whitelist, DIP switch 4 is set to an ungrounded state and the BLE module 63 ignores all MAC addresses except those that are stored in the memory 65. To clear the list, remove power from the memory 65, which erases any saved data.

Presented below are details regarding how the Fleet Manager software 18 displays and uses the information the reader 14 collects and sends.

Tags

The BLE tag reader 14 reads all BLE tags 13 that are within its scannable range. It is the responsibility of the Fleet Manager software 18 to determine if a tag 13 is valid or invalid. Valid BLE tags 13 are tags that the end user 19 has added to the database 17a. If a tag ID is received from a BLE tag 13 that does not exist in the database 17a, the Fleet Manager software 18 ignores and discards this tag information. This data is not stored and there is no record of the tag data ever being received.

BLE tags 13 (tag IDs) can be added to Fleet Manager database 17a either manually or via file upload. When BLE tags 13 are added to the database 17a, there are two assignments that are made for the system to work properly. First, the BLE tag 13 must be assigned to an asset 12. For example, tag number 123456789 may be assigned to an asset 12 labeled “Mower 1.” Second, the BLE tag 13 must be assigned to a BLE tag reader 14. The tag-to-asset assignment is handled by the end user 19 using the Fleet Manager software 18. The tag-to-reader 14 assignment happens automatically within the software 40 based on the BLE tag reader 14 that is currently picking up the BLE tag 13. This process is referred to as auto-assignment 37 (FIG. 4) and is meant to reduce the workload the end user 19 needs to allocate to this aspect of their business by automatically assigning 37 the asset 12 the BLE tag 13 is currently assigned to, to the BLE tag reader 14 that is currently picking up the BLE tag 13.

Tags 13 that have been added appear in the provided data table and show:

Tag ID—the ID of the tag 13 in question;

Assigned To—the asset the tag 13 is assigned to;

Tag Assigned—Date/Time the tag 13 was last assigned to an asset 12;

Tag Added—Date/Time the tag 13 was added to the database 17a; an

Last Reported—Date/Time the tag 13 last reported in; used for inventory control.

The date and time the BLE tag 13 was added are tracked to show how long a specific BLE tag 13 has been in service. BLE tags 13 have a battery life of approximately 2 years and this allows end users 19 to know ahead of time when BLE tags 13 should be replaced. The date and time a BLE tag 13 was assigned to an asset 12 is tracked to determine how long an asset 12 has been assigned to the BLE tag 13.

Currently, BLE tags 13 can be deleted from the database 17a, but data relating to them cannot be edited. For the sake of historical data and reporting accuracy, BLE tags 13 are only flagged as deleted and not actually removed from the database 17a. Historical integrity is also the reason for not allowing data relating to BLE tags 13 to be edited.

Assets

Assets 12 are created, updated, deleted, assigned to groups, and assigned to BLE tags 13 using the Fleet Manager software 18. Assets 12 have the following properties:

Type—Equipment or personnel.

Name—Label of the asset 12.

Tag—The tag ID for the assigned tag 13.

Vehicle—The currently assigned GPS unit label.

Asset Group—The asset group to which the asset 12 is assigned.

Last Reported—Date/Time the asset 12 last reported in (used for inventory control).

Asset Type

An asset 12 that is set as equipment or personnel currently has no implied functionality; this property is simply for organizational purposes, and may change as needs dictate. Equipment assets 12 are simple and have no special meaning other than labeling. Driver assets 12 (or personnel assets 12) act as key fobs. That is, when a BLE reader 14 identifies a driver asset 12, the driver is automatically assigned to the vehicle 11 to which the reader 14 is attached.

Asset Groups

Asset groups provide a means of associating assets 12 with one another. This also provides an efficient means of setting up BLE alerts 39 and asset-to-driver assignment for many assets 12 at once. Asset groups may be edited and deleted. When an asset group is deleted all assets 12 with the group are updated to have no group association.

BLE Alerts

Alerts 39 for assets 12 may be configured for either a single asset 12 or a single asset group. Available alerts 39 include:

Not With Vehicle—This alert 39 triggers when the selected assigned equipment or driver tag 13 is not reported in by any vehicle 11.

With Vehicle—This alert 39 triggers when the selected equipment or driver tag 13 is reported in by any vehicle 11.

Unauthorized Vehicle—This alert 39 triggers when the selected equipment or driver tag 13 is reported in by an unauthorized vehicle 11.

Arrived At Landmark—This alert 39 triggers when the selected equipment or driver tag 13 reports in from the selected landmark.

Asset Left Landmark—This alert 39 triggers when the selected equipment or driver tag 13 reports in that it has left the selected landmark.

BLE Reports

Several reports are built into the Fleet Manager software 18 for end users 19 to use including BLE Asset Detail—This report is essentially the GTC standard detailed report with BLE events added in.

Dead Zones

When multiple vehicles 11 that are equipped with BLE tag readers 14 are in close proximity to one another, there is a possibility of each vehicle's BLE tag reader 14 picking up the BLE tags 13 of the other vehicle 11. This leads to several issues relating to alerts 39 and reports that the Fleet Manager software 18 provides. To address this issue, the systems 10, apparatus 10, methods 30 and software 40 implement “dead zones.” Dead zones are geographically defined, real world areas where the Fleet Manager software 18 ignores any BLE tag data that is received by a BLE tag reader 14. The systems 10, apparatus 10, methods 30 and software 40, 18 implement dead zones, in order to address substantially colocated BLE readers 14 inadvertently reading tags 13 of assets located in other vehicles 11.

The Fleet Manager software 18 also allows designation of software-based geographical areas called Landmarks. Dead zones are an extension of the Landmark concept, and allows end users 19 to turn any landmark into a dead zone, where BLE tag data is to be ignored.

Listener Layer

All GPS data that is received by the GTC servers 17 is processed by a Java application that may be referred to as a listener layer or listener. The listener is responsible for receiving, parsing, and storing the GPS data in the GTC databases 17a. As this relates to BLE tag data, the listener is responsible for receiving, processing, auto-assigning and storing all incoming BLE tag data in the GTC databases 17a. Data associated with BLE tags 13 that are related to an account and assigned to an asset 12 are processed, auto-assigned and stored. Additionally, if BLE tag data comes in from a BLE tag reader 14 that is in a dead zone, the data is ignored.

Key fob-like functionality is also provided by the listener. If a driver asset 12 is detected by a BLE tag reader 14, the listener is responsible for auto-assignment of the driver to the BLE tag reader's assigned vehicle 11.

To summarize the key aspects of the present invention, the configuration of the components of the systems 10 and apparatus 10, the software code 40 that runs the BLE tag reader 14, the serial connection between the BLE tag reader 14 and the modem 15a and/or optional external GPS device 15 are unique to the present invention as it pertains to telematics and asset tracking in particular. The software code 40 and processing methods used in the BLE tag reader 14 are also unique and are operative to collect the ID and RSSI from a BLE tag 13 (beacon 13), process that information in the BLE tag reader 14, and store in the memory 65 a list of BLE tags 13 (beacons 13) within a given range of the BLE tag reader 14. Constant updating of the list to keep a current (up-to-date) record (with date/time stamps) that is eventually be sent via the serial connection to the modem 15a, or to the modem 15a in the GPS unit 15 which processes and sends that information to the remote server 17 for additional processing is also unique to the present invention. No conventional hardware, software, or methods exists that works in the manner described above for use in the telematics industry.

One inherent downside to prior art technology is that available tag readers in the market scan for all tags, irrespective of vehicle 11. The systems 10, apparatus 10, methods 30, and software 40 can use uniquely encoded 36 BLE tags 13 with specific and uniquely coded IDs that can be distinguished from other manufacturer's tags. The systems 10, apparatus 10, methods 30, and software 40 may be used to create a whitelist, and the software code 40 in the BLE tag reader 14 can be updated to only report tags 13 identified in the whitelist.

For example, for company X, all tags 13 may be uniquely coded 36 (FIG. 4) to begin with “99x9,” and Company X's readers 14 would be scripted in the software 40 to only read tags 13 that begin with “99x9.” Furthermore, dead zones are a software based way to monitor tag usage, which has not heretofore been used with tag readers for use in the telematics industry.

The BLE tags 13 used in the systems 10 and apparatus 10 have the ability to monitor temperature and tire pressure of the vehicle 22, for example, which is another novel aspect of the present invention. Also, the BLE tag reader 14 can read and interpret I/O states (on/off) from the BLE tags 13, which allows an end user 19 to be “alerted” 39 in real time. For example, using this, the systems 10 and apparatus 10 can monitor and report events relating to vehicle door sensors, seat belt sensors, tow alerts (tow trucks), waste management (bin pick up), and pest control sprayers, for example, which have not been done in prior art systems.

The dead zones are a software version of a whitelist. The Fleet Manager software 18 has been updated to extend the concept of a landmark so that for designated dead zones, the software 18 ignores all BLE data that is received. It is believed that many of the alerts 39 implemented in the present invention have not been used in prior art systems. These alerts 39 may include, but not limited to, inventory 12 not with the vehicle 11, inventory 12 with the vehicle 11, unauthorized use of inventory 12, and when inventory 12 enters or leaves a landmark, for example. It is also believed that some of the reports implemented in the present invention have not be provided by prior art systems, such as a report showing historic information regarding when and/or where a BLE tag 13 has been.

It is also believed that the auto-assignment 37 feature implemented in the present invention has not been done in prior art systems. Auto-assignment provides for a large reduction in the workload of the end user by automatically assigning tags/assets to vehicles 11 based on the BLE data that is received. This may also be used to automate crew management, which is important in the telematics industry, since a great deal of time is spent trying to manage who is in a particular vehicle 11.

The present invention provides for tag-to-asset/driver association, which allows an end user 19 to assign a BLE tag 13 to a specific asset 12, vehicle 11 or driver. It is believed that this has not heretofore been implemented in telematics equipment.

Thus, exemplary tracking systems, apparatus, methods, and software using active BLE tags, a BLE tag reader, an optional GPS device, and modem, to implement asset tracking in moving vehicles, where assets may be added to and removed from the vehicle during transport, in order to continuously monitor and continuously update the presence of assets in the vehicle over time during transit and report current, up-to-date, status of the assets in the vehicle have been disclosed. It is to be understood that the above-described embodiments are merely illustrative of some of the many specific embodiments that represent applications of the principles of the present invention. Clearly, numerous and other arrangements can be readily devised by those skilled in the art without departing from the scope of the invention.

What is claimed is:

1. Apparatus for tracking assets located in or on and transported by a vehicle, which assets may be added to and removed from the vehicle during transport, using a remote server having a database and server software for processing and storing data associated with assets in the database and generating reports regarding the stored data for display to an end user, the apparatus comprising:
a modem disposed on or in the vehicle for communicating with the remote server;
one or more active Bluetooth LE (BLE) tags respectively associated with one or more assets, each tag comprising an advertising packet having a unique ID and received signal strength indicator (RSSI); and
a BLE tag reader disposed on or in the vehicle comprising a memory and software, and which is coupled to the modem, for scanning and reading the unique ID and RSSI derived from the advertising packet of each active BLE tag located within range of the reader without connecting to the BLE tag, for date and time stamping each unique ID and RSSI, for storing the unique IDs and RSSIs and date and time stamps in the memory, for removing the unique ID and RSSI of active BLE tags from the memory if the tags are not within range of the reader to maintain a list of IDs and RSSIs in the memory corresponding to a current record of assets in the vehicle over time, and for communicating the unique IDs and RSSIs and date and time stamps of active BLE tags that are currently within range of the reader at predetermined times by way of the modem to the remote server to report up-to-date status of the assets in the vehicle.

2. The apparatus recited in claim 1 wherein the BLE tags have uniquely coded IDs that define a whitelist corresponding to predefined BLE tags whose IDs and RSSIs are to be stored and transmitted to the remote server, and wherein the BLE tag reader is configured to store in the memory and transmit only BLE tags having the uniquely coded IDs.

3. The apparatus recited in claim 1 further comprising a serially connected GPS device coupled to the BLE tag reader for providing GPS location data corresponding the vehicle location.

4. The apparatus recited in claim 1 wherein the BLE tags comprise a temperature monitoring circuit for generating data indicative of the temperature of its associated asset which the software on the BLE tag reader stores and transmits data to the remote server.

5. The apparatus recited in claim 1 wherein the BLE tags have one or more settable on/off I/O states and the BLE tag reader is configured to read and interpret the on/off I/O states to provide real-time alerts for events associated with the I/O states.

6. The apparatus recited in claim 1 wherein the server software is configured to define a dead zone wherein all BLE tag data that is received from within the dead zone is ignored by the server software.

7. The apparatus recited in claim 1 wherein the software on the BLE tag reader automatically assigns tags and assets to a vehicle based on BLE data that is received by the BLE tag reader.

8. The apparatus recited in claim 1 wherein the BLE tags and BLE tag reader cooperate to implement automatic tag-to-asset association.

9. The apparatus recited in claim 1 wherein the one or more active Bluetooth LE (BLE) tags broadcast advertising packets to reveal their unique IDs (MAC addresses), RSSI values, and I/O states, if any, without pairing with the BLE tag reader.

10. A method of tracking assets located in or on and transported by a vehicle, which assets may be added to and removed from the vehicle during transport, using a remote server having a database and server software for processing and storing data associated with the assets in the database and generating reports regarding the stored data for display to an end user, the method comprising:
disposing, on or in the vehicle, a modem for communicating with the remote server, an active Bluetooth LE (BLE) tag respectively associated with each asset, each tag comprising an advertising packet having a unique ID and received signal strength indicator (RSSI), and a BLE tag reader comprising a memory and software, and which is coupled to the modem;
continuously scanning and reading the unique ID and RSSI derived from the advertising packet of each active BLE tag located within range of the BLE tag reader;
date and time stamping each unique ID and RSSI;
storing the unique IDs and RSSIs and date and time stamps in the memory;
if the ID of a BLE tag is not scanned and read within a predefined time period, removing the unique ID and RSSI from the memory to maintain a list of IDs and RSSIs in the memory corresponding to a current record of assets in the vehicle over time; and
at the end of the predefined time period, communicating the unique IDs and RSSIs and date and time stamps stored in the memory by way of the modem to the remote server to report up-to-date status of the assets in the vehicle.

11. The method recited in claim 10 further comprising uniquely coding selected BLE tags to define a whitelist, and configuring the BLE tag reader to store in the memory and transmit only the IDs and RSSIs of the uniquely coded BLE tags.

12. The method recited in claim 10 further comprising serially connecting the BLE tag reader to the to the modem.

13. The method recited in claim 10 wherein the BLE tags each have one or more settable on/off I/O states and wherein the method further comprises reading and interpreting the on/off I/O states and sending real-time alerts to the remote server for events associated with the I/O states.

14. The method recited in claim 10 further comprising creating a software-based dead zone wherein all BLE tag data that is received from within the dead zone is ignored.

15. The method recited in claim 10 further comprising automatically assigning tags and assets to a vehicle based on BLE data that is received by the BLE tag reader.

16. Asset tracking software for tracking assets located in or on and transported by a vehicle, which assets may be added to and removed from the vehicle during transport, using a remote server having a database and data processing software for processing and storing data associated with assets in the database and generating reports regarding the stored data for display to an end user, the vehicle having a modem for communicating with the remote server, the asset tracking software comprising:
a computer program embodied on a non-transitory computer readable medium disposed on a BLE tag reader comprising a memory and that is coupled to the modem, which reader communicates with active Bluetooth LE (BLE) tags associated with respective assets, each tag comprising an advertising packet having a unique ID and received signal strength indicator (RSSI), the computer program comprising:
a code segment that continuously scans and reads the unique ID and RSSI derived from the advertising packet of each active BLE tag located within range of the BLE tag reader;
a code segment that date and time stamps each unique ID and RSSI;
a code segment that stores the unique IDs and RSSIs and date and time stamps in the memory;
a code segment that, if the ID of a BLE tag is not scanned and read within a predefined time period, removes the unique ID and RSSI from the memory to maintain a list of IDs and RSSIs in the memory corresponding to a current record of assets in the vehicle over time; and
a code segment that, at the end of the predefined time period, communicates the unique IDs and RSSIs and date and time stamps stored in the memory by way of the modem to the remote server to report up-to-date status of the assets in the vehicle.

17. The asset tracking software recited in claim 16 wherein selected BLE tags are uniquely coded to define a whitelist, wherein the BLE tag reader is configured to store the uniquely coded IDs and RSSIs, and wherein the software further comprises a code segment for storing and transmitting the uniquely coded IDs and RSSIs to the remote server.

18. The asset tracking software recited in claim 16 further comprising a code segment for serially connecting the BLE tag reader to the to the GPS device and modem.

19. The asset tracking software recited in claim 16 wherein the BLE tags each have one or more settable on/off I/O states and wherein the asset tracking software further comprises code segments for reading and interpreting the on/off I/O states and sending real-time alerts to the remote server for events associated with the I/O states.

20. The asset tracking software recited in claim 16 further comprising a code segment for automatically assigning tags and assets to a vehicle based on BLE data that is received by the BLE tag reader.
